(19) United States
(12) Patent Application Publication
(10) Pub. No.: US 2014/0304324 A1
(43) Pub. Date: Oct. 9, 2014

(54) CONTENT MANAGEMENT APPARATUS, CONTENT MANAGEMENT METHOD, AND PROGRAM

(71) Applicant: CANON KABUSHIKI KAISHA, Tokyo (JP)

(72) Inventor: Kensuke Hirata, Kawasaki-shi (JP)

(21) Appl. No.: 14/244,798

(22) Filed: Apr. 3, 2014

(30) Foreign Application Priority Data
Apr. 5, 2013 (JP) 2013-079731

(51) Int. Cl. H04L 29/08

(52) U.S. Cl. CPC H04L 67/36; H04L 67/02; H04L 67/06
USPC 709/203

(57) ABSTRACT

When a management apparatus receives a content sharing request, the apparatus uploads information about the content to a microblog service by using an authority of a first user who made the sharing request, associates an identifier for determining the information with the content. Next, when the apparatus receives a display request for the content, the apparatus transmits an acquisition request of the uploaded information corresponding to the identifier associated with the requested content by using an authority of a second user who made the display request, to the microblog service. If the apparatus determines that the uploaded information can be acquired, the apparatus permits displaying of the content corresponding to the display request. Otherwise, the apparatus denies displaying of the content corresponding to the display request. In this way, a sharing relationship among users in the microblog service and content access rights can be associated with each other.

### BACKGROUND OF THE INVENTION

1. Field of the Invention

The present invention relates to a content management apparatus, a content management method, and a program.

2. Description of the Related Art

In recent years, with the developments in network infrastructure, faster network lines have been available. As a result, grid computing techniques have been improving. Accordingly, cloud computing systems have begun to be widely used as modes in which server computers manage document files or form data and perform various types of processing. Users can use browsers of client computers to access World Wide Web (web) pages of cloud services via the Internet and can upload, download, display, or share the document files or form data.

Some of such cloud services include a microblog function. The microblog function is a communication service. With the microblog function, each user having their own service account can upload short messages. A unique identifier is allocated to each of the user messages uploaded.

In addition, each user has their own web page called “timeline” and messages uploaded by them, messages uploaded by other users followed by them, and messages uploaded for their own groups are displayed on their timeline. (i.e. the posted messages are displayed on their timelines). Thus, users can communicate with each other by using a function called “follow” or “group”. By using this “follow” function, a user can register other users so that messages uploaded by such other users can be displayed on his/her own web page. In addition, this “group” signifies a user group consisting of users having common characteristics, such as a group belonging to an organization or a project. Messages uploaded for a group can only be displayed on the web pages of the users belonging to this group. Chatter of Salesforce.com. is an example of the above microblog service.

A system for coordinating a managing service for contents such as document files or form data with a microblog service is also known. In such coordination, a user can upload uniform resource locator (URL) information for accessing a content, to the microblog service, to share the content with other users. Users can access the content by using the access URL information displayed on their timelines of the microblog service.

Meanwhile, regarding content management, it is important to control access to contents from users and/or groups. As conventional access control methods for information sharing systems such as a content management system and a microblog service, integral management by a directory service system or coordination between systems are known, for example.

In addition, in recent years, along with transition of an application platform from an Operating System (OS) to a cloud computing system, various types of cloud services having different security domains have been increasingly available. Consequently, different services are increasingly operating in coordination with each other. If cloud services have different security domains, access control needs to be performed on the web. Thus, in conventional directory service systems, access control cannot be integrally managed. In addition, Japanese Patent Application Laid-Open No. 2011-128775 discusses a method for performing access control on the web based on social graph information about users having requested browsing contents and content owners (co-relationship among users) or based on group attributes.

However, with the access control method discussed in Japanese Patent Application Laid-Open No. 2011-128775, unless a group of a microblog service matches the social graph information, a user cannot refer to a content shared in the microblog service. In such cases, it is not until the user presses a link to a content shared in the microblog service that the user notices that the user does not have an access right to the content. Therefore, the access control method has a problem of poor user-friendliness.

### SUMMARY OF THE INVENTION

A content management apparatus according to the present invention includes a management unit configured to manage a content, an upload unit configured to upload, when receiving a content sharing request, information about the content to an upload management service, using an authority of a first user who made the sharing request, a storage unit configured to store an upload identifier for determining the information uploaded to the upload management service by the upload unit in association with the content, a reception unit configured to receive a content display request, a transmission unit configured to transmit, when the reception unit receives the display request, an acquisition request of the uploaded information corresponding to the upload identifier associated with the content corresponding to the display request, using an authority of a second user who made the display request to the upload management service, a determination unit configured to determine whether the uploaded information corresponding to the acquisition request transmitted by the transmission unit can be acquired, and a display control unit configured to permit, if the determination unit determines that the uploaded information corresponding to the acquisition request can be acquired, displaying of the content corresponding to the display request and to deny, if the determination unit determines that the uploaded information corresponding to the acquisition request cannot be acquired, displaying of the content corresponding to the display request.

Further features of the present invention will become apparent from the following description of exemplary embodiments with reference to the attached drawings.

### BRIEF DESCRIPTION OF THE DRAWINGS

FIG. 1 illustrates a configuration of a content sharing system.

FIG. 2 illustrates a hardware configuration of a client apparatus, a microblog service, and a document management service.

FIG. 3 illustrates a configuration of software modules that operate on the microblog service.

FIG. 4 illustrates a login screen and an authorization screen.

FIG. 5 illustrates user information, group information, client information, and token information.

FIG. 6 illustrates message information and comment information.

FIGS. 7A & 7B illustrates timeline screens.

FIG. 8 illustrates a configuration of software modules that operate on the document management service.

FIG. 9 illustrates document information, message information, user information, and authentication token information.

FIG. 10 illustrates a login screen.

FIG. 11 illustrates a preview screen.

FIG. 12 illustrates a sharer selection screen.

FIG. 13 illustrates a sharing permission designation screen.

FIG. 14 illustrates a document registration screen.

FIG. 15 is a sequence diagram illustrating a process for displaying a preview screen.

FIG. 16 is a flow chart illustrating a process performed by the document management service in step S1506 in FIG. 15.

FIG. 17 is a sequence diagram used when a message is uploaded to the microblog service.

### DESCRIPTION OF THE EMBODIMENTS

Various exemplary embodiments, features, and aspects of the invention will be described in detail below with reference to the drawings.

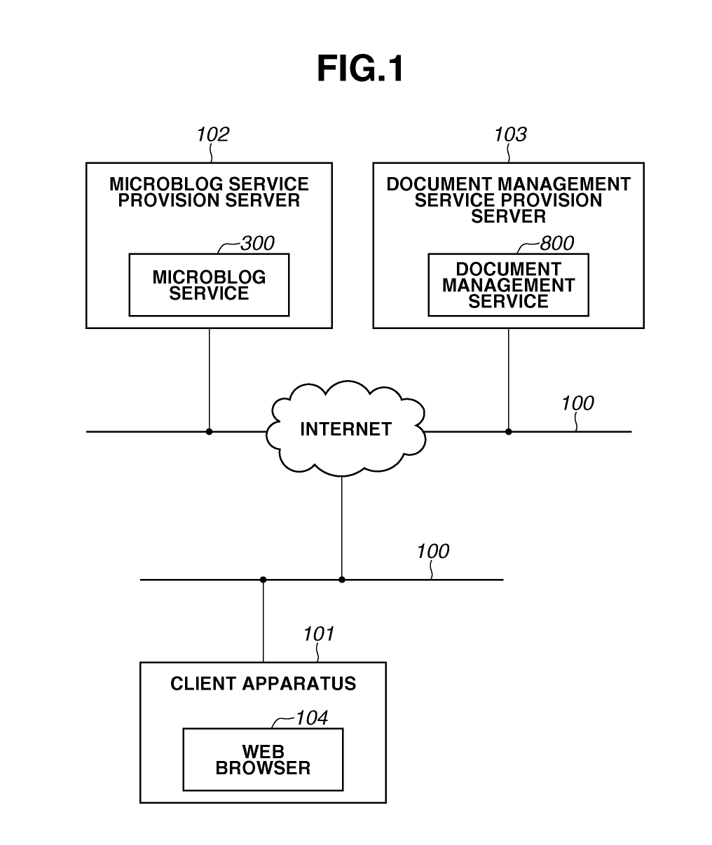

Hereinafter, an exemplary embodiment of the present invention will be described with reference to the drawings. FIG. 1 illustrates a configuration of a content sharing system. The content sharing system includes a client apparatus 101, a microblog service provision server 102, and a document management service provision server 103. These apparatuses 101 to 103 are connected to each other via a network 100 so that the apparatuses 101 to 103 can communicate with each other.

Examples of the network includes a local area network (LAN) and a wide area network (WAN) such as the Internet, a telephone line, a dedicated digital line, an Asynchronous Transfer Mode (ATM), a frame relay line, a cable television line, and a data broadcasting wireless line. In addition, the network may be a communication network realized by a combination of these examples. An arbitrary network may be used as long as data can be transmitted and received via the network. A different communication means may be used between services. For example, a communication means from the client apparatus 101 to the microblog service provision server 102 may be different from that from the client apparatus 101 to the document management service provision server 103.

The client apparatus 101 issues requests to the microblog service provision server 102 and the document management service provision server 103. The microblog service provision server 102 writes and reads messages and provides user information, in response to requests from the client apparatus 101 and the document management service provision server 103. The microblog service provision server 102 manages information such as messages and comments uploaded (posted) by users. The microblog service provision server 102 is an example of an apparatus performing an upload management service.

The document management service provision server 103 manages documents as contents and is an example of an apparatus performing a content management service. The document management service provision server 103 performs document management (content management) such as registration, deletion, browsing, and update of documents in response to requests from the client apparatus 101. The document management service provision server 103 processes electronic data (files) such as text documents and image documents. The document management service provision server 103 stores documents each of which is associated with a unique URL. Documents stored in the document management service provision server 103 can be shared by users or groups managed by the document management service provision server 103. The document management service provision server 103 is an example of a content management apparatus.

In the content sharing system, information about the documents managed by a document management service provided by the document management service provision server 103 is uploaded to a microblog service provided by the microblog service provision server 102. In this way, documents can be shared among users registered in the microblog service.

The present exemplary embodiment will be described assuming that the apparatuses 103 and 102 perform the document management service and the microblog service, respectively. However, any one of the apparatuses included in the content sharing system may perform these services. For example, the microblog service and the document management service may be provided within the same apparatus. These services may be realized on at least one virtual server of a cloud platform.

<Hardware Configuration>

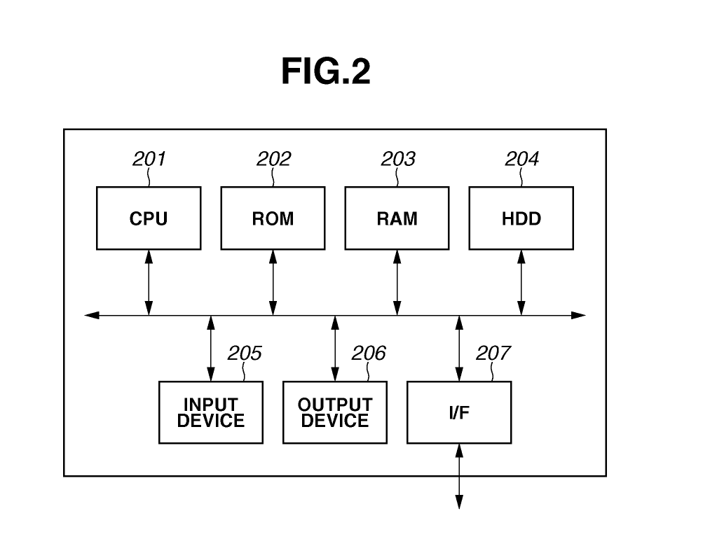

FIG. 2 illustrates a hardware configuration of the client apparatus 101, the microblog service provision server 102, and the document management service provision server 103 in FIG. 1. A central processing unit (CPU) 201 directly or indirectly controls various devices (a read-only memory (ROM) 202, a random access memory (RAM) 203, etc.) connected via an internal bus and executes programs for realizing various functions. The ROM 202 stores a basic input/output system (BIOS), for example. The RAM (direct storage device) 203 is used as a work area by the CPU 201 and as a temporary storage area to which software modules for realizing various functions are loaded. A hard disk drive (HDD) 204 stores an OS as a basic software and programs of software modules. An input device 205 is a keyboard or a pointing device (not illustrated), for example. An output device 206 is a display device such as a display. An interface (I/F) 207 is arranged for connection to the network 100.

In the hardware devices, after the apparatus is started, the CPU 201 starts the BIOS and loads the OS from the HDD 204 to the RAM 203 so that the OS can be executed. In accordance with operations of the OS, the CPU 201 loads programs of various types of software modules from the HDD 204 to the RAM 203 as needed so that these programs can be executed. The programs of various types of software modules are executed and operated by the CPU 201, in coordination with each of the above devices. In addition, the I/F 207 is connected to the network 100 and is controlled by the CPU 201 in accordance with operations of the OS. The I/F 207 realizes communication by the above communication means.

Alternatively, the computer hardware resources such as the CPU 201, the ROM 202, the RAM 203, the I/F 207, and the HDD 204 illustrated in FIG. 2 may be virtualized. In addition, software may be operated on a cloud platform opening a platform for operating virtualized software. A software program on such cloud platform is expanded to the RAM 203 of the cloud platform and is executed by the CPU 201. Since large amounts of computer resources are virtualized by the cloud platform, the software does not need to be aware of the computer resources operating on the background of the cloud platform. In some cases of typical cloud platform modes, an OS or a Web application can be registered. In the present exemplary embodiment, the mode of the cloud platform is not limited. Software on the cloud platform realizes the communication by the above communication means via the virtualized I/F 207.

<Client Apparatus 101>

The client apparatus 101 is a client computer for performing information processing. As described above, each software module that operates on the client apparatus 101 is realized by causing the CPU 201 to load a program stored in the HDD 204 to the RAM 203 and to execute the program. The client apparatus 101 is connected to the network 100 via the I/F 207. The client apparatus 101 may be a computer to which a persistent storage device is connected or may have a thin-client configuration including a temporary storage device.

The client apparatus 101 includes a web browser 104. The client apparatus 101 uses the web browser 104 to transmit requests to the microblog service 300 and the document management service 800. The web browser 104 analyzes Hyper Text Markup Language (HTML) received from the microblog service 300 or the document management service 800 and displays various types of information, such as results of the analysis, on a display device serving as the output device 206.

<Software Module Configuration of Microblog Service Provision Server 102>

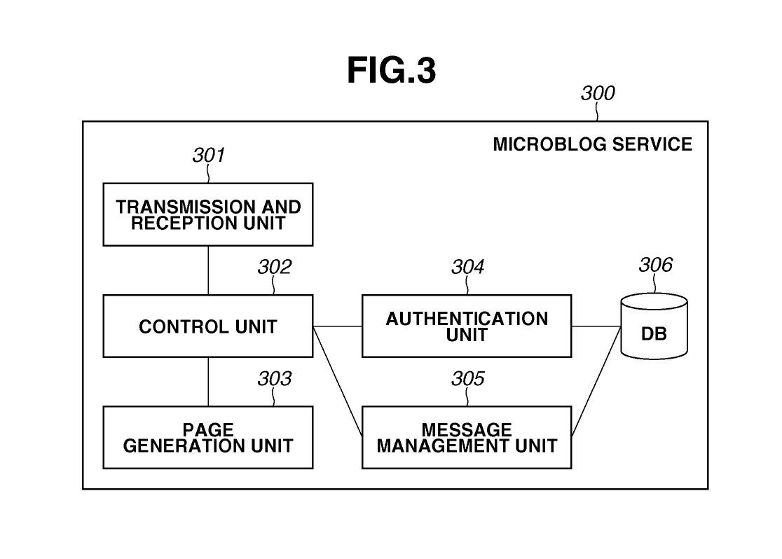

FIG. 3 illustrates a configuration of software modules (the microblog service 300) that operate on the microblog service provision server 102. Each software module functions as a processing unit performing each of the processes described below, by causing the CPU 201 to load a program stored in the HDD 204 illustrated in FIG. 2 to the RAM 203 and to execute the program. The microblog service 300 includes a transmission and reception unit 301, a control unit 302, a page generation unit 303, an authentication unit 304, and a message management unit 305. The authentication unit 304 and the message management unit 305 refer to a database (DB) 306 that is stored in the HDD 204 illustrated in FIG. 2, for example.

The transmission and reception unit 301 processes communication between the web browser 104 of the client apparatus 101 and the document management service 800. The control unit 302 performs processes in accordance with requests received by the transmission and reception unit 301. The page generation unit 303 generates a web page for transmitting a response to the web browser 104.

The authentication unit 304 authenticate users having transmitted login requests and manages access rights such as user information, group information, client information, and token information. The DB 306 stores the authentication data to which the authentication unit 304 refers when managing the access rights. The message management unit 305 stores message data in the DB 306 and acquires and updates messages in the DB 408 in response to requests. The DB 306 stores message data relating to the microblog service 300 and information about the above access rights.

<Authentication/Authorization by Microblog Service 300>

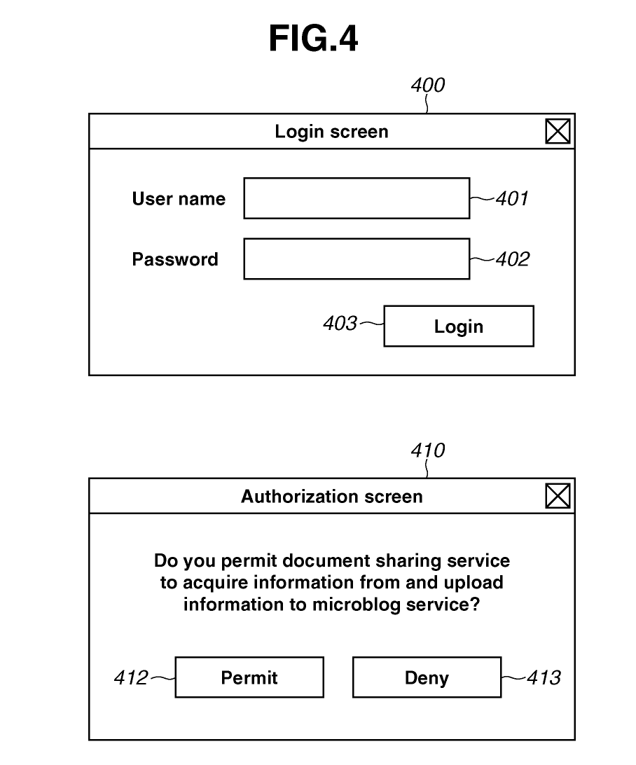

FIG. 4 illustrates a login screen 400 and an authorization screen 410. The login screen 400 and the authorization screen 410 are generated by the page generation unit 303 of the microblog service 300 and are displayed by the web browser 104 of the client apparatus 101.

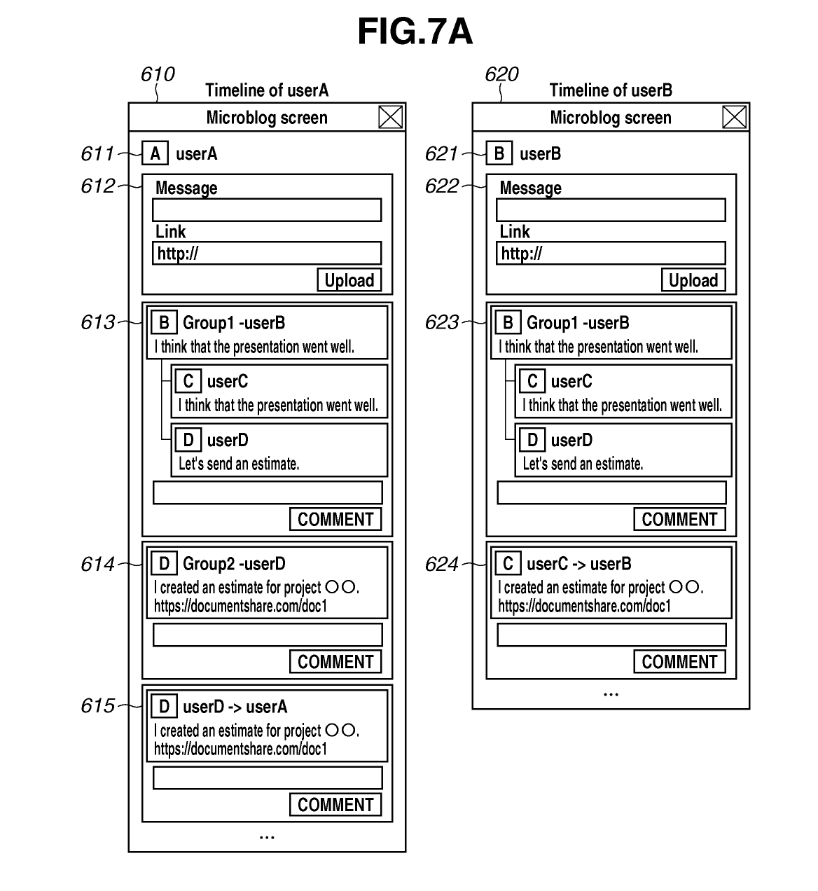

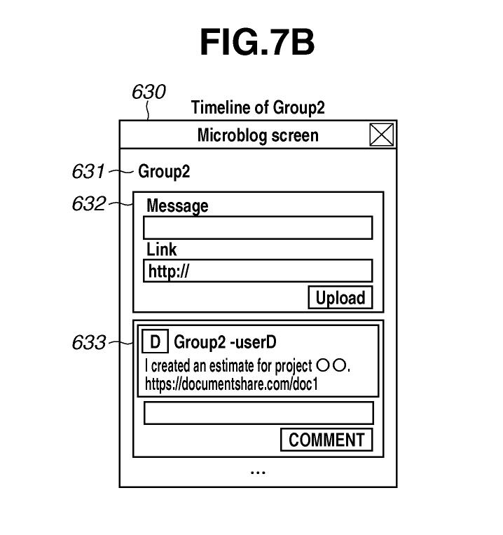

First, when the web browser 104 transmits a request to the microblog service 300, the transmission and reception unit 301 receives the request. Next, the control unit 302 transmits the request to the authentication unit 304. When receiving the request, the authentication unit 304 determines whether the authentication session is valid. Next, the authentication unit 304 notifies the control unit 302 of whether the authentication session is valid or invalid. If the authentication session is invalid, the control unit 302 causes the page generation unit 303 to generate the login screen 400 and transmits the login screen 400 as a response to the request. If the authentication session is valid, the control unit 302 causes the page generation unit 303 to generate the authorization screen 410 and a timeline screen (FIG. 7A-B) in response to the request. The control unit 302 transmits the generated authorization screen 410 and timeline screen as a response to the request.

The authentication unit 304 manages an authentication session by using an authentication token. If successful authentication is performed, the authentication unit 304 transmits an authentication token to the web browser 104. The web browser 104 can continue authentication by adding the authentication token to a request. All the requests to the microblog service 300 are managed by the authentication unit 304 through sessions.

When the microblog service 300 receives a request, the authentication unit 304 always checks the request through an authentication session. However, in the following description, for simplicity, checking of each request through an authentication session will not be described.

As illustrated in FIG. 4, the login screen 400 includes a user name 401, a password 402, and a login button 403. The user name 401 is an entry field for a user name and the password 402 is an entry field for a password necessary for authentication in the microblog service 300. When the login button 403 is pressed, the web browser 104 transmits a login request including the entered user name 401 and password 402 as parameters to the microblog service 300.

The authorization screen 410 includes an authorization message 411, a “Permit” button 412, and a “Deny” button 413. The authorization screen 410 is a screen for asking a user whether to permit (authorize) the document management service 800 to access information managed by the microblog service 300. The OAuth protocol is generally used as an authorization method and the authorization screen 410 is an example of an authorization screen defined by the OAuth protocol.

When generating, acquiring, updating, or deleting information relating to the microblog service 300, the document management service 800 transmits an authorization request including a scope as a parameter to the microblog service 300 via the web browser 104. This scope indicates a range of authorization permission. The document management service 800 according to the present exemplary embodiment designates acquiring of information from and uploading of information to the microblog service 300 as the scope (range of authorization).

When the transmission and reception unit 301 of the microblog service 300 receives the authorization request, the control unit 302 instructs the page generation unit 303 to generate the authorization screen 410. Next, the control unit 302 transmits the authorization screen 410 in response to the authorization request from the web browser 104.

The authorization message 411 is a message for presenting information relating to authorization, to the user. In FIG. 4, the authorization message 411 is asking the user whether to authorize the document management service 800 to acquire information from and upload messages to the microblog service 300 as indicated by the scope. If the “Permit” button 412 is pressed, the web browser 104 transmits an authorization permission request to the microblog service 300. If “Deny” button 413 is pressed, the web browser 104 transmits an authorization denial request to the microblog service 300. When the transmission and reception unit 301 of the microblog service 300 receives the authorization permission request, the authentication unit 304 issues an authorization code. The authorization code is transmitted to the document management service 800 via the web browser 104.

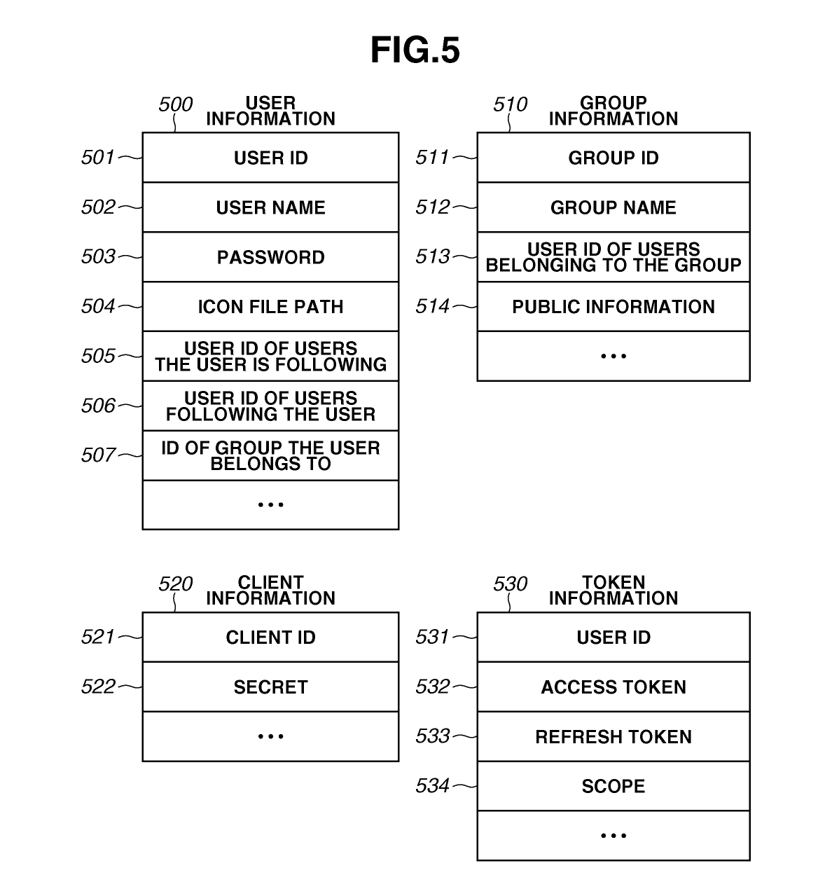

The document management service 800 transmits a token acquisition request including the received authorization code and client information as parameters to the microblog service 300. When receiving the token acquisition request, the microblog service 300 determines whether the requested client information matches client information 520 (FIG. 5) and issues token information 530.

The microblog service 300 transmits an access token 532 and a refresh token 533 to the document management service 800 as a response to the token acquisition request. The document management service 800 adds the access token 532 to a request to the microblog service 300. In this way, the document management service 800 can make a request in the scope of the microblog service 300.

The refresh token 533 is a token for updating the access token 532. When receiving a refresh token and client information in a token update request, the microblog service 300 determines whether the refresh token and client information match the respective refresh token 533 and the client information 520 stored in the microblog service 300.

If the microblog service 300 determines that the client information matches the client information 520, the microblog service 300 updates the access token 532 and the refresh token 533. The microblog service 300 transmits the updated new access token 532 and refresh token 533 as a response to the token update request. Expiration dates are set to the access token 532 and the refresh token 533. If the access token 532 expires, the access token 532 is updated by using the refresh token 533.

FIG. 5 illustrates user information 500, group information 510, the client information 520, and the token information 530 stored in the DB 306 managed by the authentication unit 304 of the microblog service 300.

The user information 500 is information about a user registered in the microblog service 300. The user information 500 includes a user ID 501, a user name 502, a password 503, an icon file path 504, a user ID 505 of a user this user is following, a user ID 506 of a user following this user, and a group ID 507 of a group this user belongs to. The user ID 501 is an identifier for uniquely determining the user information 500. The user name 502 and the password 503 are a user name and a password necessary for authentication. The icon file path 504 is a path to a file in which an icon image representing this user is stored.

The user ID 505 is an ID of a user this user is following, and a plurality of user IDs can be stored. The user ID 506 is an ID of a user following this user, and a plurality of user IDs can be stored. This function “follow” will be described below. The group ID 507 is Ann ID of a group this user belongs to, and a plurality of group IDs can be stored.

The group information 510 is information about a group a user registered in the microblog service 300 belongs to. The group information 510 includes a group ID 511, a group name 512, a user ID 513 of a user belonging to this group, and public information 514. A user can generate a group and belong to this generated group. The group ID 511 is an identifier for uniquely determining the group information 510. The group name 512 is a name allocated to this group. The user ID513 is a user ID of a user belonging to this group, and a plurality of user IDs can be stored. The public information 514 is a flag for determining whether users other than the user belonging to this group can access the microblog service 300, and “public” or “non-public” is set to the flag.

The client information 520 includes a client ID 521 and a secret 522. The client ID 521 is an identifier for uniquely determining the client information 520 about a client connected to the microblog service 300. The secret 522 is a password for the client. The microblog service 300 issues the client ID 521 and the secret 522. The client apparatus 101 can transmit an authorization permission request to the microblog service 300 by using the client ID 521 and the secret 522.

The token information 530 includes a user ID 531, the access token 532, the refresh token 533, and a scope 534. The token information 530 is information for managing tokens issued by authorization of the microblog service 300. The user ID 531 is an ID for which a token is issued. The access token 532 is a token used when the client apparatus 101 makes a request. The refresh token 533 is a token for updating the access token 532. The scope 534 is information specifying a range of authorization.

<Microblog Function of Microblog Service 300>

The microblog service 300 provides a microblog function. The microblog function is a function of sharing messages uploaded to the microblog service 300 by a user with other users or among a certain group. Users can upload messages, upload messages for groups, and browse shared messages, for example. In addition, the microblog service 300 provides a function of making comments on uploaded messages.

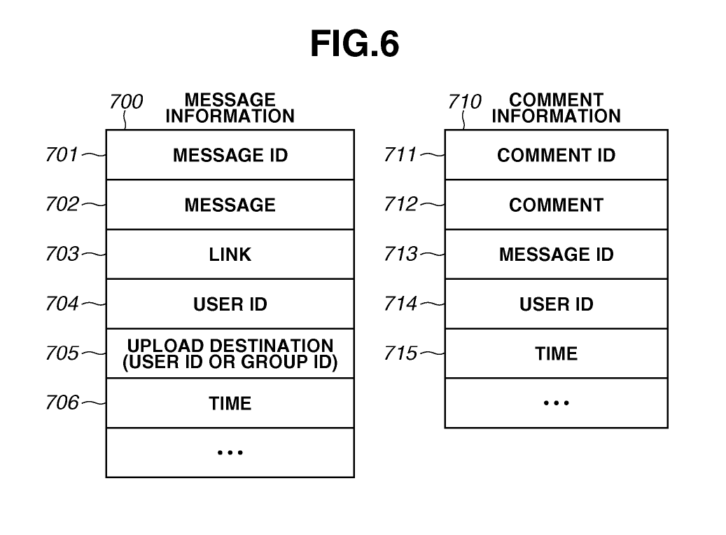

FIG. 6 illustrates message information 700 and comment information 710. The message information 700 is information about a message uploaded to the microblog service 300. The comment information 710 is information about a comment uploaded to the microblog service 300.

The message information 700 includes a message ID 701, a message 702, a link 703, a user ID 704, an upload destination 705, and time 706. The message information 700 is generated by the message management unit 305 when the microblog service 300 receives a message upload request, which is a request for uploading a message. The message information 700 is stored in the DB 306. The message ID 701 is a upload identifier for uniquely determining the message information 700. The message 702 is a character string representing an uploaded message. The link 703 is an uploaded URL. The user ID 704 is an uploaded user ID.

The upload destination 705 is an uploaded destination. The upload destination 705 is information indicating a message sharing user, that is, a user sharing a message, which is a content uploaded by a user. More specifically, a user ID or a group ID is stored in the upload destination 705. A plurality of user IDs or group IDs may be stored in the upload destination 705. While not registered in the upload destination 705, since the user who has also uploaded this message naturally shares the uploaded content, this user is included as the message sharing user. If no message destination is specified, no information is stored in the upload destination 705. The time 706 represents the upload date and time of the message. The message sharing user is an example of an uploaded-content sharing user. In this way, in the message information 700 in the microblog service 300, the message ID is associated with the upload-destination user ID or group ID e. The message ID is an example of an upload identifier. The group ID is an example of information about an uploaded-content sharing user.

The comment information 710 includes a comment ID 711, a comment 712, a message ID 713, a user ID 714, and time 715. The comment information 710 is generated by the message management unit 305 when the microblog service 300 receives a comment upload request. The comment information 710 is stored in the DB 306. The comment ID 711 is an identifier for uniquely determining the comment information 710. The comment 712 is a character string representing an uploaded comment. The message ID 713 is an ID of the message information 700 on which this comment has been made. The user ID 714 is an ID of a user who has made this comment. The time 715 represents the upload date and time of the comment.

The message information 700 and the comment information 710 are stored in the DB 306. Namely, the DB 306 associates a message ID with message sharing user information and stores the associated information.

FIG. 7A-7B illustrates timeline screens. A timeline screen 610 is a screen of a user having a user name “userA.” A timeline screen 620 is a screen of a user having a user name “userB.” A timeline screen 630 is a screen of a group having a group name “Group2.”

If the microblog service 300 successfully authenticates a user, the microblog service 300 generates a timeline screen of the authenticated user and transmits the timeline screen to the web browser 104. Each of the timeline screens 610 and 620 of the respective users includes a user information display area (611, 621), a message upload area (612, 622), and comment upload areas (613 to 615, 623, 624).

The user information display area (611, 621) includes an user icon and a user name. As the user icon, an image stored in an area specified by the icon file path 504 is displayed. As the user name, information in the user name 502 is displayed. The message upload area (612, 622) includes a message entry field, a link entry field, and an “Upload” button. If the “Upload” button is pressed, the web browser 104 transmits a message upload request including information entered in the message entry field and the link entry field as parameters, to the microblog service 300. When receiving the message upload request, the microblog service 300 generates the message information 700. After that, the microblog service 300 regenerates a timeline screen and transmits the timeline screen to the web browser 104.

Each comment upload area (613 to 615, 623, 624) includes a message display area, at least one comment display area, a comment entry field, and a “Comment” button. The message display area includes a user icon of a user who uploaded a message, a user name, an upload destination, a message, and a link. The user icon is an image stored in an area specified by the icon file path 504 associated with the user ID 704. The upload destination is the user name 502 or the group name 512 associated with a user ID or a group ID stored in the upload destination 705.

In each comment display area, comment information having the message ID 713 matching the message ID 701 of the message displayed in the message display area is displayed in reverse chronological order based on time 715. Each comment display area includes a user icon of a user who uploaded a comment, the user name 502, and the comment 712. The user icon is an image stored in an area specified by the icon file path 504 associated with the user ID 714. If the “Comment” button is pressed, the web browser 104 transmits a comment upload request including data entered in the comment entry field as a parameter to the microblog service 300. When receiving the comment upload request, the microblog service 300 generates the comment information 710, regenerates a timeline screen, and transmits the timeline screen to the web browser 104.

The comment upload area 613 is an example in which comments from userC and userD made on a message uploaded by userB for Group1 are displayed. The comment upload area 614 is an example in which a message uploaded by userD for Group2 and a link are displayed.

The comment upload area 615 is an example in which a message uploaded by userD for userA and a link are displayed. The comment upload area 623 displays the same information as that in the comment upload area 613. The comment upload area 624 is an example in which a message uploaded by userC for userB and a link are displayed.

The message information 700 displayed on a timeline screen of one user satisfies the following three conditions. The first condition is that the user ID 704 matches the user ID 501 or the user ID 505 of a user this user is following. The second condition is that the user ID in the upload destination 705 matches the user ID 501 of this user. The third condition is that the group ID in the upload destination 705 matches the group ID 507 of a group this user belongs to.

Each user can use their timeline screen to browse timeline screens of other users. The timeline screens of other users are linked to respective user names on the timeline screen. Thus, when such links are pressed, the timeline screens of other users are displayed.

The message information 700 displayed on the timelines of other users satisfies the following three conditions. The first condition is that the user ID 704 matches the user ID 501 of this user or a display user. The second condition is that the user ID 704 matches the user ID 505 of a user a display user is following. The third condition is that the group ID in the upload destination 705 matches the group ID 507 of a group a display user belongs to and that the public information 514 is set “public.”

The message information 700 satisfying the above conditions and the comment information 710 associated with a message is displayed on the timeline screen of a user. The message information 700 and the comment information 710 is displayed in each comment display area in reverse chronological order based on the time 706 and the time 715, respectively.

The timeline screen 630 in FIG. 7B is a timeline screen of Group2. Each of the relevant timeline screens has a group name linked to the timeline screen 630 of the group. When the link is pressed, timeline screen 630 is displayed. The timeline screen of the group includes a group information display area 631, a message upload area 632, and a comment upload area 633. In the group information display area 631, information in the group name 512 is displayed. While the message upload area 632 is similar to the message upload area (612, 622) on the timeline screen of a user, a message is uploaded for the group. The comment upload area 633 is the same as the comment upload area (613 to 615, 623, 624) on the timeline screen of a user.

The message information 700 displayed on the timeline screen 630 of the group satisfies the following conditions. The first condition is that the group ID in the upload destination 705 matches the group ID 511 of the display group. The second condition is that the group ID 511 of the display group matches the group ID 507 of a group the display user belongs to. The third condition is that the public information 514 about the display group is set “public.”

The message information 700 satisfying the above conditions and the comment information 710 associated with a message are displayed on the timeline screen of a group. The message information 700 and the comment information 710 are displayed in each comment display area in reverse chronological order based on the time 706 and the time 715, respectively.

<Web Application Programming Interface (API) of Microblog Service 300>

The microblog service 300 provides a Web API. The Web API is a function of registering, acquiring, updating, or deleting information managed by the microblog service 300 in response to a request. Examples of the information managed by the microblog service 300 include the user information 500, the group information 510, the token information 530, the message information 700, and the comment information 710.

For example, for the client apparatus 101 to transmit a request to the Web API, the client apparatus 101 needs to perform the above authorization and adds the access token 532, the client ID 521, and the secret 522 to the request. The client apparatus 101 can transmit a request for registering, acquiring, updating, or deleting the user information 500, the group information 510, the message information 700, or the comment information 710, to the Web API. In addition, the client apparatus 101 can transmit a token update request, a user timeline acquisition request, and a group timeline acquisition request, to the Web API.

The token update request is a request for updating the access token 532. The microblog service 300 adds the refresh token 533, the client ID 521, and the secret as parameters of the token update request to regenerate and transmit the access token 532 and the refresh token 533. The user timeline acquisition request is a request for acquiring a timeline corresponding to the user ID 501 specified by a parameter.

Information that can be acquired by the user timeline acquisition request is the message information 700 and the comment information 710 displayed in the comment upload areas (613 to 615, 623, 624) on the timeline screen of a user in FIG. 7A. The conditions for the message information 700 that can be acquired by the user timeline acquisition request are the same as the above conditions for the message information 700 that are displayed on the timeline screen of a user.

The group timeline acquisition request is a request for acquiring a timeline corresponding to the group ID 511 specified by a parameter. Information that can be acquired by the group timeline acquisition request is the message information 700 and the comment information 710 displayed in the comment upload area (633) of the timeline screen of the group in FIG. 7B. The conditions for the message information 700 that can be acquired by the group timeline acquisition request are the same as the above conditions for the message information 700 that are displayed on the timeline screen of a group.

In a request for acquiring information from the Web API, a query can be specified as a parameter. The query is a data search condition. The microblog service 300 transmits information matching the search condition specified in the query. For example, if a plurality of message IDs 701 are specified as a query in a request for acquiring message information, the microblog service 300 extracts, from the message information 700 managed thereby, all the message information 700 that matches the message IDs 701 specified in the query and transmits the extracted message information 700.

<Software Module Configuration of Document Management Service Provision Server>

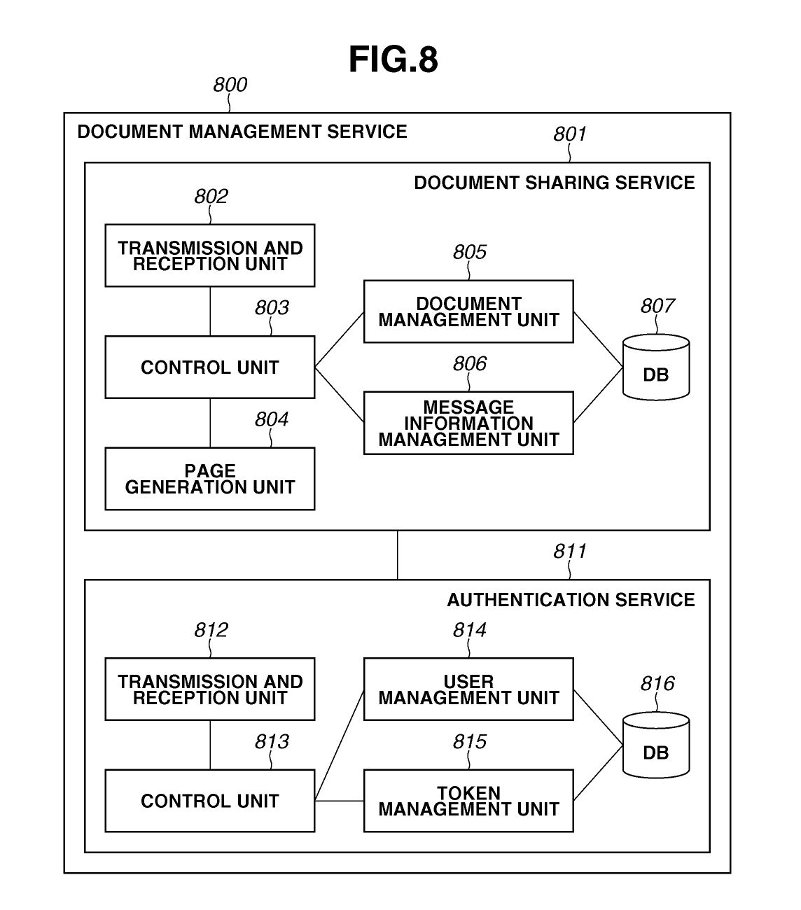

FIG. 8 illustrates a configuration of software modules (the document management service 800) that operate on the document management service provision server 103. The document management service 800 includes a document sharing service 801 and an authentication service 811. The document sharing service 801 includes a transmission and reception unit 802, a control unit 803, a page generation unit 804, a document management unit 805, and a message information management unit 806. The authentication service 811 includes a transmission and reception unit 812, a control unit 813, a user management unit 814, and a token management unit 815. A program for each software module is stored in the HDD 204 illustrated in FIG. 2. As described above, the CPU 201 loads the program to the RAM 203 and executes the program. Thus, the CPU serves as each of the processing units.

In addition, a DB 807 is a DB to which the document sharing service 801 refers and the DB 807 is stored in the HDD 204 illustrated in FIG. 2, for example. Likewise, the DB 816 is a DB to which the authentication service 811 refers and the DB 816 is stored in the HDD 204, for example.

The transmission and reception unit 802 processes communication with the web browser 104 of the client apparatus 101, the microblog service 300, and the authentication service 811. The control unit 803 performs processes in accordance with requests received by the transmission and reception unit 802. The page generation unit 804 generates a web page for transmitting a response to the web browser 104.

The document management unit 805 manages documents and document information 1400 stored in the DB 807. The document management unit 805 registers, acquires, updates, or deletes the documents and the document information 1400 in response to a request from the control unit 803, for example.

The message information management unit 806 manages message information 1410 on the DB 807. For example, the message information management unit 806 registers, acquires, updates, or deletes message information 1410 in response to a request. The message information 1410 is information for associating a document and document information 1400 with a message on the microblog service 300. In addition to such documents, document information 1400, and message information 1410, user setting information about the document sharing service 801 is also stored in the DB 807, for example.

The transmission and reception unit 812 of the authentication service 811 processes communication with the document sharing service 801. The control unit 813 performs processes in accordance with requests received by the transmission and reception unit 812. The user management unit 814 manages user information 1420 stored in the DB 816. The user management unit 814 registers, acquires, updates, or deletes the user information 1420 in response to a request from the control unit 813, for example.

The token management unit 815 manages authentication token information 1430 and microblog access token information 1440 stored in the DB 816 in which the user information 1420 is also stored. The token management unit 815 registers, acquires, updates, or deletes the authentication token information 1430 and the microblog access token information 1440 in response to a request from the control unit 813, for example.

<Information Managed by Document Management Service 800>

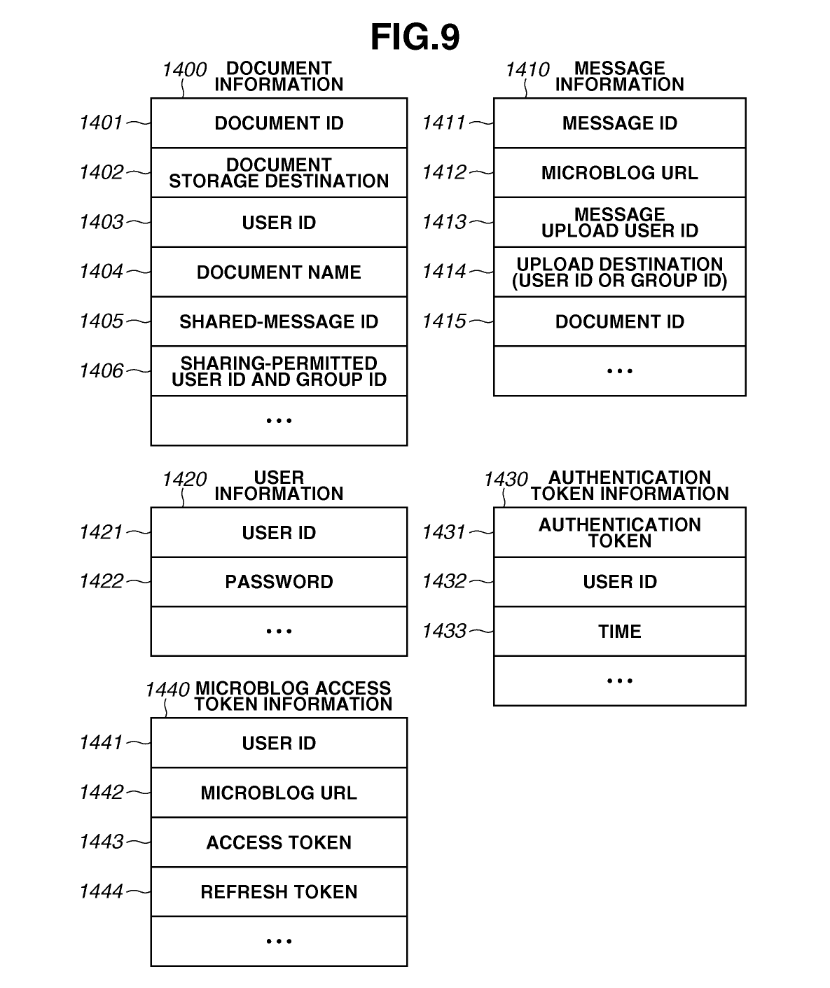

FIG. 9 illustrates the document information 1400, the message information 1410, the user information 1420, the authentication token information 1430, and the microblog access token information 1440. The document information 1400 and the message information 1410 is information stored in the DB 807 of the document sharing service 801.

The document information 1400 is information about a document as a content, namely, content information. The document information 1400 is additional information about a document. The document information 1400 includes a document ID 1401, a document storage destination 1402, a user ID 1403, a document name 1404, a shared-message ID 1405, and a sharing-permitted user ID and group ID 1406. The document ID 1401 is an identifier for uniquely determining a document. The document storage destination 1402 is information indicating a file path, a URL, or the like necessary for accessing the document. The document is stored in the HDD 204 of the document management service provision server 103. Alternatively, the document may be stored in a different device. In such cases, information necessary for accessing the device storing the document is stored in the document storage destination 1402.

The user ID 1403 indicates a user who created and registered the document in the document management service 800. Namely, the user ID 1403 is an identifier of the document creator. The document name 1404 is the title of the document and is a character string that can be arbitrarily determined by the user. The shared-message ID 1405 is an upload identifier issued when the document information 1400 is uploaded to the microblog service 300. Namely, the shared-message ID 1405 is information corresponding to the message ID 701 in the microblog service 300. The sharing-permitted user ID and group ID 1406 are a user ID or a group ID as to which the user who created the document permits sharing of the document. The sharing-permitted user ID and group ID 1406 is an example of a document sharing user (content sharing user) representing a user sharing the document (content). Other than the above items of information, the document information 1400 may include arbitrary information relating to the document such as the size of the document and the number of pages.

The message information 1410 includes information relating to messages uploaded to the microblog service 300 for documents stored in the document management service provision server 103. The message information 1410 includes a message ID 1411, a microblog URL 1412, a message upload user ID 1413, an upload destination 1414, and a document ID 1415. The message ID 1411 is an identifier for uniquely determining a message on the microblog service 300. The message ID 1411 is an upload identifier issued by the microblog service 300 when a message is uploaded.

The microblog URL 1412 is a URL for accessing the microblog service 300. In the microblog URL 1412, for example, an endpoint URL of a web service of the microblog service 300 is stored. The message upload user ID 1413 is a user ID of the user who uploaded the message on the microblog service 300. The upload destination 1414 is information indicating an ID of a user or a group to which the message is uploaded on the microblog service 300. The document ID 1415 is an identifier for associating the document information 1400 with the message information 1410. The document information 1400 and the message information 1410 which associate the shared-message ID 1405 and the sharing-permitted user ID and group ID 1406 with the document ID is stored in the DB 807.

The user information 1420, the authentication token information 1430, and the microblog access token information 1440 are information stored in the DB 816 of the authentication service 811. The user information 1420 is information about a user registered in the document management service 800. The user information 1420 includes a user ID 1421 and a password 1422. The user ID 1421 is an identifier for uniquely determining a user in the document management service 800. The password 1422 is a password used for authentication along with the user ID 1421 when the user logs-in the document management service 800 via the web browser 104. Other than these items of information, the user information 1420 may include arbitrary information relating to the user such as the name of the user and a mail address of the user.

The authentication token information 1430 is authentication information about a user who has already logged-in the document management service 800. The authentication token information 1430 includes an authentication token 1431, a user ID 1432, and time 1433. The authentication token 1431 indicates that the user has already been authenticated, and is a unique character string at least in the document management service 800. The user ID 1432 is information representing the user ID of the authenticated user. The date and time for determining the expiration date of the authentication token 1431 is stored in the time 1433.

The microblog access token information 1440 is user authorization information necessary when the document management service 800 accesses the microblog service 300. The microblog access token information 1440 includes a user ID 1441, a microblog URL 1442, an access token 1443, and a refresh token 1444.

The user ID 1441 is an identifier for determining a user on the document management service 800. The user ID 1441 corresponds to the user ID 1421 in the user information 1420. The microblog URL 1442 is the microblog URL in which the microblog access token information 1440 is used. The microblog URL 1442 corresponds to the microblog URL 1412 in the message information 1410. The access token 1443 is a character string including authorization information necessary for accessing the microblog URL 1442 with the user ID 1441. In addition, the refresh token 1444 is a token necessary for updating the access token 1443 issued by the microblog service 300.

<Authentication by Document Management Service 800>

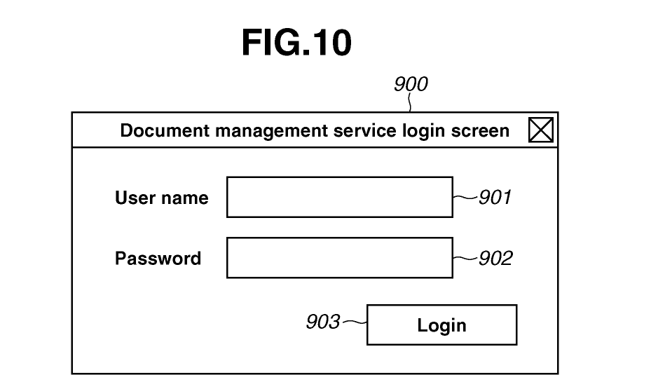

FIG. 10 illustrates a document management service login screen 900 displayed by the web browser 104 of the client apparatus 101. The page generation unit 804 of the document management service 800 generates the document management service login screen 900.

When the web browser 104 transmits a request to the document management service 800, the transmission and reception unit 802 receives the request. Next, the control unit 803 transmits an authentication check request to the authentication service 811 via the transmission and reception unit 802.

The control unit 803 determines whether the request includes the authentication token 1431. If so, the control unit 803 transmits the authentication token 1431 to the authentication service 811. The authentication service 811 uses the transmission and reception unit 812 to receive a request. Next, the control unit 813 requests the token management unit 815 to check the validity of the authentication token information 1430. The control unit 813 receives a result indicating whether the authentication token 1431 is valid, from the token management unit 815. The control unit 813 transmits the result of the validity check to the document sharing service 801 via the transmission and reception unit 812.

When checking the validity of the authentication token 1431, the token management unit 815 refers to the authentication token information 1430. Whether the target authentication token 1431 is stored and the target authentication token 1431 has not expired based on the time 1433 is checked, for example. If the authentication token 1431 is invalid, the control unit 803 of the document sharing service 801 instructs the page generation unit 804 to generate the document management service login screen 900. In addition, the control unit 803 transmits the generated document management service login screen 900 in response to the request. If the authentication token 1431 is valid, the control unit 803 generates and transmits the preview screen 1000 in response to the request.

The document management service login screen 900 includes a user name 901, a password 902, and a login button 903. The user name 901 and the password 902 are entry fields for the user ID and the password necessary for authentication by the document management service 800. If the login button 903 is pressed, the web browser 104 transmits a login request including information entered in the user name 901 and the password 902 as a parameter to the document management service 800.

After the web browser 104 transmits the login request, the control unit 813 of the authentication service 811 checks the validity. The control unit 813 checks whether the combination of the user name 901 and the password 902 included in the login request exists in the user information 1420 in association with each other.

If the combination included in the login request exists in the user information 1420, the control unit 813 issues the authentication token information 1430. Next, the control unit 813 stores the authentication token information 1430 in the DB 816 and transmits the authentication token 1431 to the web browser 104.

By adding the acquired authentication token 1431 to each request, the web browser 104 can continue the authentication. The authentication service 811 performs authentication management on all the requests transmitted to the document management service 800. When the document management service 800 receives a request, the authentication information is always checked. However, in the following description, for simplicity, checking of the authentication information will not be described.

<Document Preview by Document Sharing Service 801>

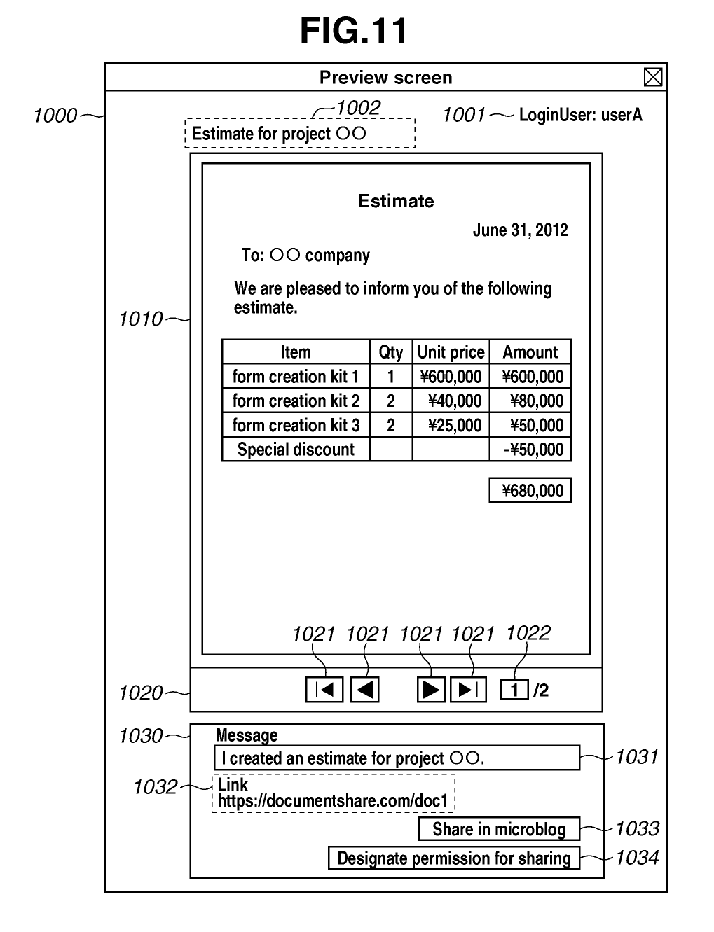

FIG. 11 illustrates the preview screen 1000 for a document to be displayed by the web browser 104 of the client apparatus 101. The page generation unit 804 of the document sharing service 801 generates the preview screen 1000. To generate the preview screen 1000, first, the web browser 104 transmits a document preview request including information identifying a document, to the document sharing service 801. When the transmission and reception unit 802 receives the request, the control unit 803 acquires corresponding document information 1400 from the document management unit 805.

The information identifying a document transmitted from the web browser 104 can be a URL including the document ID 1401, for example. By referring to the document ID 1401 included in this URL, the control unit 803 can acquire the document information 1400 corresponding to the request from the document management unit 805. The control unit 803 refers to the acquired document information 1400 and instructs the page generation unit 804 to generate the preview screen 1000 that can be displayed by the web browser 104. In addition, the control unit 803 transmits the generated preview screen 1000 to the web browser 104 via the transmission and reception unit 802.

The preview screen 1000 displays a document image 1010 acquired by referring to the document storage destination 1402 in the document information 1400, a document name 1002, and a user name 1001, for example. In a preview operation area 1020, a button 1021 for changing pages, an area 1022 for entering a display page, etc. are displayed.

A message upload area 1030 is an area for uploading a message to the microblog service 300. The message upload area 1030 includes a message entry field 1031, link information 1032, a “Share in microblog” button 1033, and a “Designate permission for sharing” button 1034. The link information 1032 displays a URL including the document ID 1401 identifying the document being previewed. If the web browser 104 transmits a request to the URL including the document ID 1401, the preview screen 1000 displaying the document identified by the document ID 1401 is displayed.

If the “Share in microblog” button 1033 is pressed, the web browser 104 transmits a sharing request including the message entered in the message entry field 1031 and the link information 1032 as parameters, to the document sharing service 801. When receiving the sharing request, the document sharing service 801 generates a sharer selection screen 1100 and transmits the generated sharer selection screen 1100 to the web browser 104. A method for generating the sharer selection screen 1100 and the sharer selection screen 1100 will be described in detail below.

If the “Designate permission for sharing” button 1034 is pressed, the web browser 104 transmits a sharing permission designation request to the document sharing service 801. When receiving the sharing permission designation request, the document sharing service 801 generates a sharing permission designation screen 1200 and transmits the generated sharing permission designation screen 1200 to the web browser 104. A method for generating the sharing permission designation screen 1200 and the sharing permission designation screen 1200 will be described in detail below.

<Sharer Selection in Document Sharing Service 801>

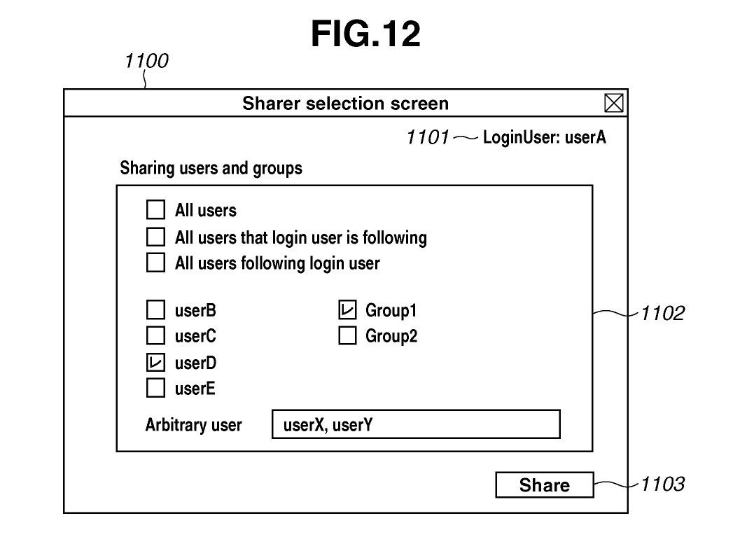

FIG. 12 illustrates the sharer selection screen 1100 displayed by the web browser 104 of the client apparatus 101. The page generation unit 804 of the document sharing service 801 generates the sharer selection screen 1100. The sharer selection screen 1100 is a screen for selecting a user or a group to which the message entered in the message entry field 1031 on the preview screen 1000 illustrated in FIG. 11 is uploaded. The sharer selection screen 1100 includes a user name 1101, a selection area 1102, and a “Share” button 1103. In the selection area 1102, the users registered in the document management service 800 and the groups to which these registered users belong are displayed as the choices for the upload destinations.

If the “Share” button 1103 is pressed, the web browser 104 transmits a sharing request including the selected items 1102 and the entered user name in the selection area as parameters, to the document sharing service 801. The sharing request is a request for registering users who share the message. In accordance with the sharing request received by the transmission and reception unit 802, the document management unit 805 of the document sharing service 801 registers the corresponding user ID or group ID as message sharing user information in the upload destination 705 of the message information 700.

If “All users” is checked in the selection area 1102, the message is uploaded without designating a user or a group. If “All users that login user is following” is checked in the selection area 1102, the message is uploaded to the user ID(s) 505 that the login user is following as the upload destination(s) 705. If “All users following login user” is checked in the selection area 1102, the message is updated to the user ID(s) 506 following the login user as the upload destination(s) 705. If a user or a group is selected in the selection area 1102, the message is updated to the selected user or group as the upload destination 705. If an arbitrary user is entered in the selection area 1102, the message is uploaded to the user ID or group ID of the entered user as the upload destination 705. The user ID(s) 505 that the login user is following and the user ID(s) 506 following the login user are displayed in the selection area.

If the message is uploaded, the transmission and reception unit 802 of the document sharing service 801 receives the upload destination 705 specified by message uploading. Namely, the process by the transmission and reception unit 802 is an example of a first selection processing for receiving at least one user or group sharing the message, from a message upload user.

Since the users and groups registered in the microblog service 300 are displayed on the sharer selection screen 1100 before a message is uploaded to the microblog service 300, the user can designate a desired sharer from among the displayed choices. In addition, on the sharer selection screen 1100, based on the user information 500 of the upload user, users registered as the user ID(s) 505 that the login user is following and as the user ID(s) 506 following the login user are selectably displayed, for example. In this way, user operations for selecting desired upload destinations can be simplified.

<Selection of Permission for Sharing by Document Sharing Service 801>

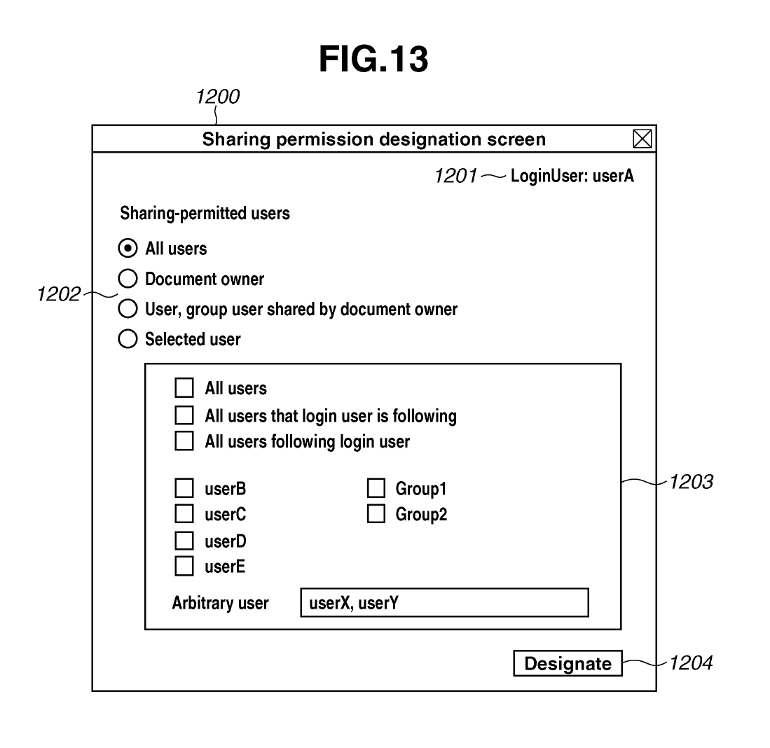

FIG. 13 illustrates the sharing permission designation screen 1200 displayed by the web browser 104 of the client apparatus 101. The sharing permission designation screen 1200 is displayed by the page generation unit 804 of the document sharing service 801, based on the user information 500 and the group information 510 received by the transmission and reception unit 802 from the microblog service 300. The user information 500 and the group information 510 is an example of registration information in the microblog service 300.

The sharing permission designation screen 1200 is a screen for the document owner to designate a user permitted to share the document (a user who can share the document), that is, a user who can share the document displayed on the preview screen 1000 illustrated in FIG. 11. The sharing permission designation screen 1200 is a screen displayed only for the document owner, namely, the user who created the document. Only the document owner can designate permission for sharing. Namely, the process by the transmission and reception unit 802 is an example of a second reception process. In addition, the process by the page generation unit 804 is an example of a second screen generation process for generating a sharing permission designation screen.

The sharing permission designation screen 1200 includes a user name 1201, a selection area 1202, a user designation area 1203, and a “Designate” button 1204. For example, users registered in the document management service 800 and groups to which the registered users belongs are displayed in the selection area 1202 as the choices for the users and groups permitted to share the document. If the “Share” button 1103 is pressed, the web browser 104 transmits a sharing permission designation request including the selection items in the selection area 1202 and the user designation area 1203 and the entered user name as parameters to the document sharing service 801.

The transmission and reception unit 802 of the document sharing service 801 receives the sharing permission designation request. Namely, the transmission and reception unit 802 receives at least one user or group who is to share the document from the document creator. The document management unit 805 changes values in the sharing-permitted user ID and group ID 1406, based on the selected item and the entered user name included in the sharing permission designation request.

If “All users” is checked in the selection area 1202, the web browser 104 transmits the checked content to the document management service 800. In the document management service 800, the transmission and reception unit 802 of the document sharing service 801 receives the checked content. Next, the document management unit 805 of the document sharing service 801 changes the values in the sharing-permitted user ID and group ID 1406 to a value indicating all users in accordance with the checked content. Namely, the process by the transmission and reception unit 802 is an example of a second selection reception process for receiving at least one user or group who shares the document (content), from the document owner (content creator).

If “Document owner” is checked in the selection area 1202, the document management unit 805 deletes the values in the sharing-permitted user ID and group ID 1406. If “User, group user shared by document owner” is checked in the selection area 1202, the document management unit 805 changes the values in the sharing-permitted user ID and group ID 1406 to the user ID of the document owner.

If “All users login user is following” is checked in the user designation area 1203 in the selection area 1202, the document management unit 805 stores the user ID(s) 505 that the login user is following in the sharing-permitted user ID and group ID 1406. In addition, if “All users following login user” is checked in the user designation area 1203 in the selection area 1202, the document management unit 805 stores the user ID(s) 506 following the login user in the sharing-permitted user ID and group ID 1406.

If “Selected user” is designated in the selection area 1202, in accordance with the designation in the user designation area 1203, information in the sharing-permitted user ID and group ID 1406 is stored, as described below. The users and the groups displayed in the user designation area 1203 correspond to the user ID(s) 505 that the login user is following and the user ID(s) 506 following the login user.

If a user or a group is selected in the user designation area 1203, the document management unit 805 stores the selected user ID or group ID in the sharing-permitted user ID and group ID 1406. If an arbitrary user is entered in the user designation area 1203 in the selection area 1202, the document management unit 805 stores the entered user ID or group ID in the sharing-permitted user ID and group ID 1406.

In this way, on the sharing permission designation screen 1200, the users and groups who can upload messages to the microblog service 300 are displayed to enable the user to select a desired user or group. Thus, the user can designate a sharing-permitted user(s) and/or group(s) with a simple operation.

<Registration of Document in Document Sharing Service 801>

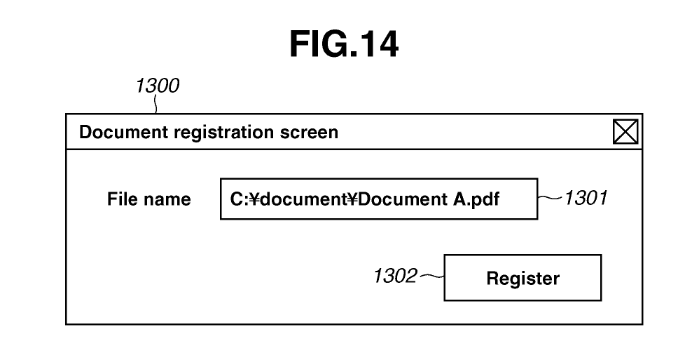

FIG. 14 illustrates a document registration screen 1300 displayed by the web browser 104 of the client apparatus 101. When the web browser 104 of the client apparatus 101 transmits a document registration screen display request by accessing the document sharing service 801, the page generation unit 804 of the document sharing service 801 generates the document registration screen 1300.

The document registration screen 1300 includes a file name 1301 for specifying a document to be registered and a “Register” button 1302. If the “Register” button 1302 is pressed, the client apparatus 101 issues a document registration request for transmitting a document specifying the file name 1301 to the document management service 800.

If the user presses the “Register” button 1302 on the document registration screen 1300, the web browser 104 transmits the document and the document registration request to the document sharing service 801. When receiving the document registration request, the document sharing service 801 stores document data in the HDD 204 and generates the document information 1400.

In other ways, documents may be registered in the document sharing service 801. For example, a document registration service may be provided as an external service, and documents may be registered on the document registration screen 1300 of the document registration service. In such cases, the document registration service receives the document registration request. Next, the document registration service forwards the document registration request to a Web API of the document sharing service 801 via the network 100. The Web API of the document sharing service 801 is the same as the Web API of the microblog service 300. The Web API is a function of registering, acquiring, updating, and deleting data managed by the document sharing service 801.

<Document Preview Screen Display>

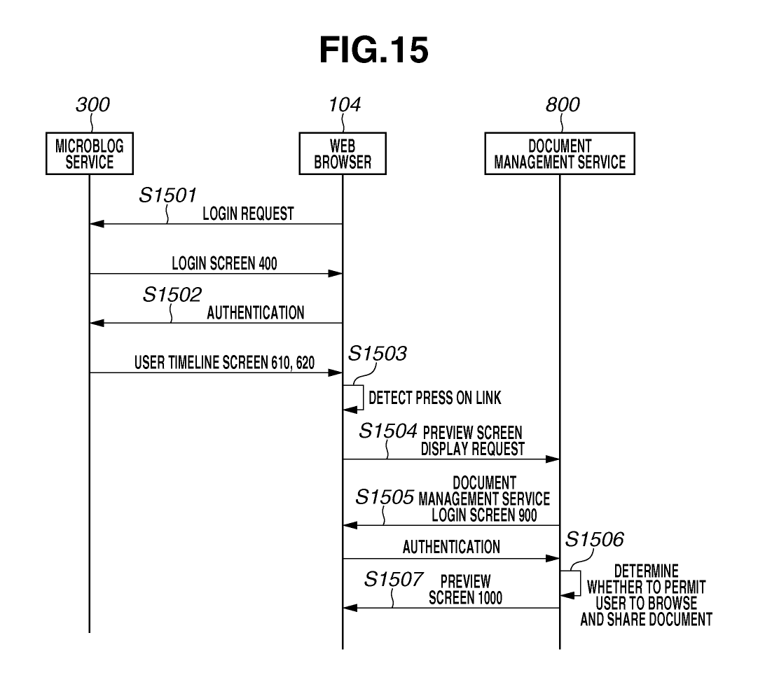

FIG. 15 is a sequence diagram illustrating a process for displaying the preview screen 1000. After logging in to the microblog service 300, when a user presses a document URL displayed on the timeline screen 610 or 620 of the user, the preview screen 1000 is displayed.

First, in step S1501, the microblog service 300 receives a login request from the web browser 104 of the client apparatus 101. When receiving the login request, the microblog service 300 transmits the login screen 400. In addition, in step S1502, the microblog service 300 performs user authentication, based on the information entered on the login screen 400 of the web browser 104.

If successful authentication is performed, the microblog service 300 transmits the timeline screen 610 or 620 of the user. As in the comment upload areas 614, 615, and 624, links to the document management service 800 are uploaded on the user timeline screens 610 and 620 displayed by the web browser 104. In addition, the document ID 1401 for determining a document is added to a link.

Next, in step S1503, the web browser 104 detects a press on a link to the document management service 800 displayed on the user timeline screen 610 or 620. Consequently, in step S1504, the web browser 104 transmits a preview screen display request to the document management service 800.

If the user has not logged in to the document management service 800 yet, in step S1505, the document management service 800 transmits the document management service login screen 900. Next, the document management service 800 performs user authentication, based on the content entered on the document management service login screen 900. If the user has already logged in to the document management service 800, step S1505 is not performed.

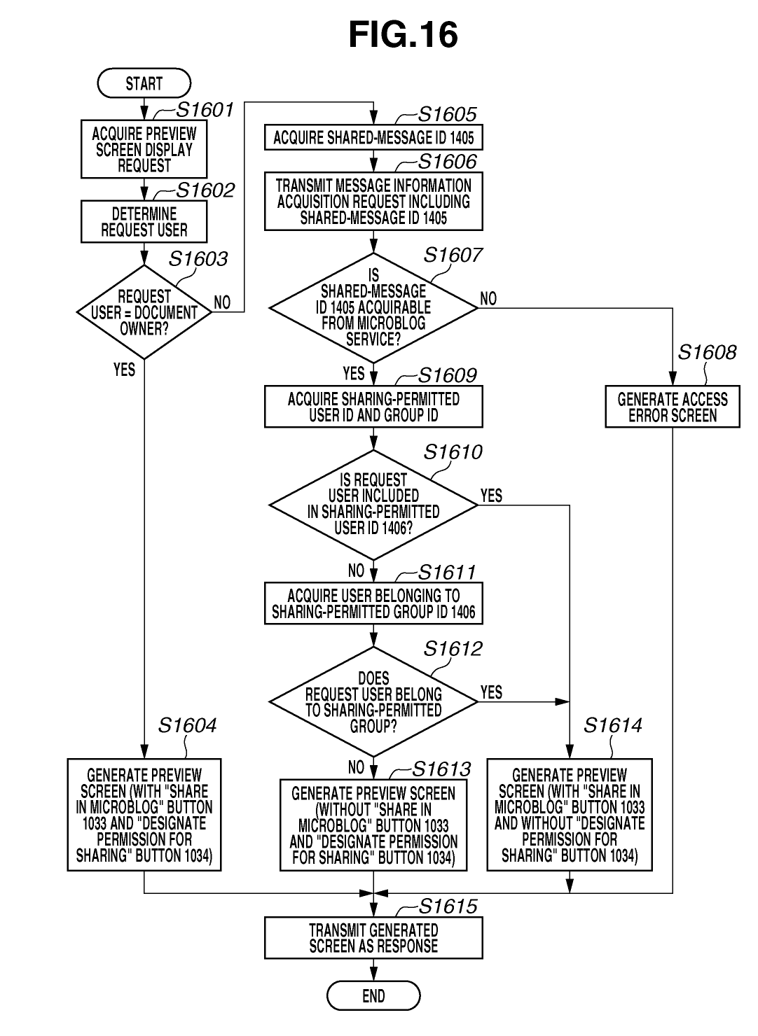

Next, in step S1506, the document management service 800 determines whether to permit the login user to browse the document corresponding to the preview screen display request, upload messages for the document, and share the document. This determination in step S1506 will be described in detail below with reference to FIG. 16.

Next, if the document management service 800 determines that the document can be displayed in step S1506, in step S1507 the document management service 800 generates the preview screen 1000 and transmits the generated preview screen 1000 to the web browser 104. In this way, the preview screen 1000 is displayed.

FIG. 16 is a flow chart illustrating a process performed by the document management service 800 in step S1506 in FIG. 15. Namely, the flow chart illustrates a process in which the document management service 800 receives the preview screen display request from the web browser 104, performs successful authentication, and transmits a response.

First, in step S1601, the document management service 800 acquires the preview screen display request. An authentication token issued to the request user having transmitted the request is added to the preview screen display request. This preview screen display request is an example of a document (content) display request. In addition, the request user is an example of a display request source user. Step S1601 is an example of a display request reception process. In addition, the authentication token is information issued to the source user and corresponds to source user information indicating a source user.

Next in step S1602, the user management unit 814 of the document management service 800 determines the request user based on the authentication token. Next, in step S1603, the document management unit 805 of the document management service 800 determines whether the request user matches the user who registered the document, namely, the document owner. More specifically, the document management unit 805 refers to the document information 1400 and compares the user ID of the request user with the user ID 1403.

If both user's IDs match, namely, if the request user is the document owner (YES in step S1603), the operation proceeds to step S1604. In step S1604, the page generation unit 804 generates the preview screen 1000.

In step S1603, if the request user matches the document owner (YES in step S1603), the document management unit 805 permits the request user to browse the document, upload messages to the document, and share the document. Next, in step S1064, the page generation unit 804 displays the preview screen 1000, based on the determination (permission for displaying the document) by the document management unit 805.

In addition, the page generation unit 804 adds the “Share in microblog” button 1033 to the preview screen 1000, based on the determination (permission for uploading messages to the document) by the document management unit 805. In addition, the page generation unit 804 adds the “Designate permission for sharing” button 1034 to the preview screen 1000, based on the determination (permission for designating permission for sharing the document) by the document management unit 805.

However, in step S1603, if the request user does not match the document owner (NO in step S1603), the document management unit 805 performs step S1605. In step S1605, the document management unit 805 acquires the shared-message ID 1405 for the document corresponding to the preview screen display request via the control unit 803.

Next, in step S1606, the transmission and reception unit 802 transmits a message information acquisition request including the shared-message ID 1405 as a parameter to the microblog service 300. In step S1606, the transmission and reception unit 802 transmits the message information acquisition request using the access token 1443 of the request user. The message information acquisition request is an example of an upload acquisition request including a message ID as an upload identifier. Step S1606 is an example of a first transmission process.

When acquiring the message information acquisition request, the microblog service 300 refers to the token information 530 and identifies the user ID of the request user from the access token. Next, the microblog service 300 refers to the message information 700 stored in the DB 306 and identifies the message information 700 that the request user can browse. Namely, the microblog service 300 identifies the message information 700 in which the request user is specified as a message sharing user. A message sharing user is a user registered in the user ID 704 and the upload destination 705 in the message information 700.

In the present exemplary embodiment, a user registered in the user ID 704 and the upload destination 705 in the message information 700 is determined as a message sharing user. However, the present invention is not limited to such an example. An apparatus designer or the like may set an arbitrary user as a message sharing user and register such arbitrary user as the message information 700, for example.

More specifically, the microblog service 300 identifies the message information 700 having the user ID 704 or the upload destination 705 in which the user ID of the request user is stored as the message information 700 that can be browsed by the request user.

In addition, the microblog service 300 identifies the message information 700 having the upload destination 705 in which the group ID of a group to which the request user belongs is stored as the message information 700 that can be browsed by the request user. When identifying a group to which the request user belongs, the microblog service 300 refers to the user information 500 or the group information 510.

Thus, if the microblog service 300 identifies the message information 700, the microblog service 300 transmits the identified message information 700 to the document management service 800. If not, the microblog service 300 does not transmit the message information 700.

Namely, if the message information 700 in which the request user is specified as a message sharing user, exists, the document management service 800 can acquire the message information 700. Namely, the message information 700 is information that is transmitted only when the request user is specified as a message sharing user.

The document management service 800 can determine whether the request user is specified as a message sharing user, based on reception of the message information 700. Namely, the message information 700 is an example of matching information transmitted when the request user is specified as a message sharing user.

Next, in step S1607, the document management unit 805 determines whether the transmission and reception unit 802 of the document management service 800 has acquired the message information 700 as for the message acquisition request transmitted in step S1605. If the transmission and reception unit 802 acquires the message information 700 (YES in step S1607), the document management unit 805 permits displaying the preview screen 1000, and the operation proceeds to step S1609.

In step S1607, if the transmission and reception unit 802 does not acquire the message information 700 (NO in step S1607), the document management unit 805 denies displaying the preview screen 1000, and the operation proceeds to step S1608. Step S1607 is an example of a first reception process for receiving matching information and a display control process for determining whether to display the preview screen 1000.

In step S1607, if the transmission and reception unit 802 does not acquire the message information 700, namely, if the request results in an error (NO in step S1607), the operation proceeds to step S1608. In step S1608, the page generation unit 804 generates an access error screen. While the access error screen will not be described in detail, the access error screen is a screen showing a message to the effect that previewing the document is not possible without an access authority.

In this way, in the content sharing system according to the present exemplary embodiment, if the request user does not have an access right to the document, the page generation unit 804 displays an access error screen, instead of a preview screen. Conventionally, there are cases where a preview screen is displayed to a user and a link to a document is denied since the user has no access right. However, according to the present invention, such inconvenience can be prevented.

In step S1607, if the transmission and reception unit 802 acquires the message information 700, namely, if the request is successfully accepted (YES in step S1607), the document management unit 805 performs step S1609. Namely, in step S1609, the document management unit 805 acquires the sharing-permitted user ID and group ID 1406 from the DB 807.

Information about a document sharing permission user (content sharing permission user) who is permitted to further share the document, namely, content sharing permission user information, is registered in the sharing-permitted user ID and group ID 1406.

Next, the document management unit 805 determines whether the user ID of the request user is specified as a user ID for the sharing-permitted user ID and group ID 1406. If the request user is specified as a user ID for the sharing-permitted user ID and group ID 1406 (YES in step S1610), the document management unit 805 permits the request user to share the document such as uploading messages. In step S1614, the page generation unit 804 generates the preview screen 1000 including the “Share” button 1033. The “Designate permission for sharing” button 1034 is not added on the preview screen 1000 generated in step S1614.

In step S1610, if the user ID of the request user is not specified as a user ID for the sharing-permitted user ID and group ID 1406 (NO in step S1610), the document management unit 805 performs step S1611. Namely, in step S1611, from the microblog service 300, the document management unit 805 acquires the user ID 513 belonging to the group ID 1406 permitted for sharing by the request user from the DB 807.

Next, the document management unit 805 refers to the user ID of the request user and determines whether the request user is specified as a user belonging to the group acquired in step S1611.

In step S1612, if the request user belongs to the sharing-permitted group ID 1406 (YES in step S1612), the document management unit 805 permits the request user to share the document such as uploading messages. Next, in step S1614, the preview screen 1000 including the “Share” button 1033 is generated.

However, in step S1612, if the request user does not belong to the sharing-permitted group ID 1406 (NO in step S1612), the document management unit 805 denies sharing of the document by the request user, such as uploading messages. Next, in step S1613, the page generation unit 804 generates the preview screen 1000 without the “Share” button 1033 and the “Designate permission for sharing” button 1034.

Next, in step S1615, the transmission and reception unit 802 transmits the screen generated in step S1604, S1613, S1614, or S1608 to the web browser 104.

Steps S1610 and S1612 are examples of a second management process in which the request user determines whether to deny uploading messages to his/her contents.

As described above, in the content sharing system according to the present exemplary embodiment, the “Share” button 1033 is displayed to the user or group users designated on the sharing permission designation screen 1200. The sharing permission designation screen 1200 can be displayed only to the document owner. In contrast, the “Share” button 1033 is not displayed to users that are not designated on the sharing permission designation screen 1200.

In this way, users who can share uploading messages can be limited. In addition, since users other than the document owner cannot share the document, it is possible to prevent addition of an access right to the document without the permission of the document owner.

<Document Sharing Sequence>

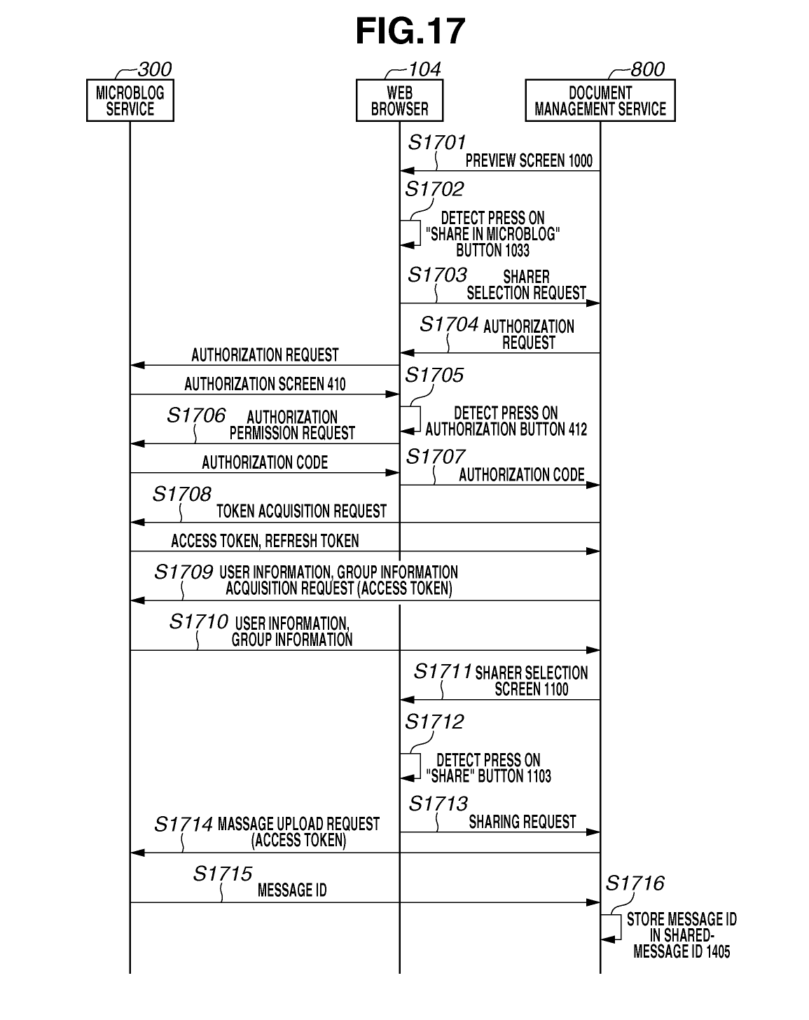

FIG. 17 is a sequence diagram used when a message is uploaded to the microblog service 300 after the preview screen 1000 generated by the document management service 800 is displayed by the web browser 104.

In step S1701, the preview screen 1000 generated by the document management service 800 is transmitted to the web browser 104 and is displayed by the web browser 104. Next, in step S1702, the web browser 104 detects a press on the “Share in microblog” button 1033 on the preview screen 1000.

Next, in step S1703, in accordance with the press on the button 1033, the web browser 104 transmits a sharer selection request to the document management service 800. A message entered to the message entry field 1031 is added as a parameter to the sharer selection request.

The following steps S1704 to S1708 correspond to an authorization flow in which the document management service 800 transmits a request to the Web API of the microblog service 300. Since the authorization by the microblog service 300 has already been described above, redundant description will be avoided.

After step S1708, in step S1709, the transmission and reception unit 802 of the document management service 800 transmits a user information acquisition request and a group information acquisition request to the microblog service 300. Subsequently, in response to the requests, in step S1710, the document management service 800 acquires the user information 500 and the group information 510 (registration information) of the login user (upload user) (second reception process). The group information 510 acquired in this step is information that matches the group ID 507 this user belongs to and the group ID 511.

Next, the page generation unit 804 uses the user information 500 and the group information 510 acquired in step S1710 to generate the sharer selection screen 1100. In step S1711, the transmission and reception unit 802 transmits the generated sharer selection screen 1100 to the web browser 104. Step S1711 is an example of a first screen generation process.

Next, if the web browser 104 detects a press on the “Share” button 1133 on the sharer selection screen 1100 in step S1712, the web browser 104 transmits a sharing request to the document management service 800 in step S1713. The information selected in the selection area 1102 on the sharer selection screen 1100 is added as a parameter to the sharing request. Namely, step S1712 is an example of a first selection reception process for receiving at least one user or group who shares messages from the upload user. In addition, steps S1703 and S1713 are examples of an upload content reception process for receiving messages and uploaded-content sharing user information.

Next, in step S1714, the transmission and reception unit 802 of the document management service 800 transmits a message upload request to the microblog service 300. As parameters of the message upload request, the user ID of the login user, the message in the sharer selection request received in step S1703, the document URL, and the upload destination described above in connection with the sharer selection screen 1100 are added. Namely, step S1714 is an example of a second transmission process for transmitting a message upload request including message sharing user information and a message, to the microblog service 300.

When receiving the message upload request from the document management service 800, the microblog service 300 issues a message ID which is an upload identifier of the message included in the message upload request. In addition, the microblog service 300 generates the message information 700 including the message ID. Next, in step S1715, the microblog service 300 transmits the message ID 701 to the document management service 800.

In this way, the microblog service 300 according to the present exemplary embodiment functions as an upload identifier management apparatus issuing the message ID as the upload identifier.

In addition, the microblog service 300 acquires the message upload request as an instruction for issuing the upload identifier. Namely, step S1714 is an example of a third transmission process for transmitting a message upload request as an upload identifier issuing instruction. In addition, step S1715 is an example of a third reception process.

Alternatively, the message ID as the upload identifier may be issued by an apparatus implementing the microblog service 300, other than the microblog service provision server 102. In such cases, the upload identifier management apparatus, which is an apparatus other than the microblog service provision server 102, transmits the issued message ID to the microblog service 300.

Next, the document management service 800 stores the message ID received as a response to the message upload request in the shared-message ID 1405. Steps S1714 and S1715 are repeated for all users and groups selected or entered on the sharer selection screen 1100.

In step S1716, the message ID as the upload identifier is stored in a storage unit in association with the document as a content, in the document information 1400. Namely, step S1716 is an example of a first management process.

The process flow in FIG. 16 and the process flow of the document management service 800 in the sequences in FIGS. 15 and 17 are stored in the HDD 204 as programs of the document management service 800. The above process flows are realized by causing the CPU 201 to load these programs to the RAM 203 and execute the programs.

In addition, programs of the document management service 800 store the information referred to in the process flows illustrated in FIGS. 15 to 17 in the HDD 204, load the information to the RAM 203, and use the loaded information. Examples of such information include the document information 1400, the message information 1410, the user information 1420, the authentication token information 1430, and the microblog access token information 1440.

As described above, in the content sharing system according to the present exemplary embodiment, a relationship about sharing among users registered in the microblog service and content access rights can be associated with each other. In this way, user operability in handling contents and uploading can be improved.

In the above description, the document management service 800 uploads messages to the microblog service 300. However, a service other than the document management service 800 or an apparatus other than the document management service provision server 103 may upload messages. For example, an external service other than the document management service 800 may upload messages to the microblog service 300. In such cases, the document management service 800 may be notified of the message ID via the Web API. In such cases, too, the document management service 800 is notified of the message ID and stores and manages the message ID in the message ID 1405.

In this way, even when messages are uploaded to another service and documents are shared, the document management service 800 can receive the message ID via the Web API and perform access control.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-079731 filed Apr. 5, 2013, which is hereby incorporated by reference herein in its entirety.

What is claimed is:

1. A content management apparatus, comprising:
a management unit configured to manage a content;
an upload unit configured to upload, when receiving a content sharing request, information about the content to an upload management service, using an authority of a first user who made the sharing request;
a storage unit configured to store an upload identifier for determining the information uploaded to the upload management service by the upload unit in association with the content
a reception unit configured to receive a content display request;
a transmission unit configured to transmit, when the reception unit receives the display request, an acquisition request of the uploaded information corresponding to the upload identifier associated with the content corresponding to the display request, using an authority of a second user who made the display request, to the upload management service;
a determination unit configured to determine whether the uploaded information corresponding to the acquisition request transmitted by the transmission unit can be acquired; and
a display control unit configured to permit, if the determination unit determines that the uploaded information corresponding to the acquisition request can be acquired, displaying of the content corresponding to the display request and to deny, if the determination unit determines that the uploaded information corresponding to the acquisition request cannot be acquired, displaying of the content corresponding to the display request.

2. The content management apparatus according to claim 1,
wherein the sharing request further includes information about at least one user or group designated as a sharer of the content by the first user.

3. The content management apparatus according to claim 2, further comprising:
an acquisition unit configured to acquire information about at least one user or group who can be a sharer candidate, from the upload management service; and
a generation unit configured to generate a sharer selection screen for allowing the first user to select a sharer, based on the information acquired by the acquisition unit,
wherein the sharing request includes information about at least one user or group designated as a sharer of the content by the first user on the sharer selection screen.

4. The content management apparatus according to claim 1,
wherein the display control unit determines, if the determination unit determines that the uploaded information corresponding to the acquisition request can be acquired and permits displaying of the content corresponding to the display request, whether the second user is permitted to share the content,
wherein, if the display control unit determines that the second user is permitted to share the content, the display control unit performs a control operation so that the content and a share button for sharing the content are additionally displayed; and
wherein, if the display control unit determines that the second user is not permitted to share the content, the display control unit performs a control operation so that the share button is not displayed and the content is displayed.

5. A content management method performed by a content management apparatus managing a content, the content management method comprising:
uploading, when a content sharing request is received, information about the content to an upload management service, using an authority of a first user who made the sharing request;
storing an upload identifier for determining the information uploaded to the upload management service in association with the content;
receiving a content display request;
transmitting, when the display request is received, an acquisition request of the uploaded information corresponding to the upload identifier associated with a content corresponding to the display request, using an authority of a second user who made the display request, to the upload management service;
determining whether the uploaded information corresponding to the transmitted acquisition request can be acquired; and
performing display control so that, if it is determined that the uploaded information corresponding to the acquisition request can be acquired, displaying of the content corresponding to the display request is permitted and if it is determined that the uploaded information corresponding to the acquisition request cannot be acquired, displaying of the content corresponding to the display request is denied.

6. A non-transitory storage medium storing a computer-executable program,
wherein the program causes a computer to function as:
an upload unit configured to upload, when receiving a content sharing request, information about the content to an upload management service, using an authority of a first user who made the sharing request;
a storage unit configured to store an upload identifier for determining the information uploaded to the upload management service in association with the content and to store the associated upload identifier and content;
a reception unit configured to receive a content display request;
a transmission unit configured to transmit, when the reception unit receives the display request, an acquisition request of the uploaded information corresponding to the upload identifier associated with the content corresponding to the display request, using an authority of a second user who made the display request, to the upload management service;
a determination unit configured to determine whether the uploaded information corresponding to the acquisition request transmitted by the transmission unit can be acquired; and
a display control unit configured to permit, if the determination unit determines that the uploaded information corresponding to the acquisition request can be acquired, displaying of the content corresponding to the display request and to deny, if the determination unit determines that the uploaded information corresponding to the acquisition request cannot be acquired, displaying of the content corresponding to the display request.
